(19) United States
(12) Patent Application Publication
(10) Pub. No.: US 2012/0057784 A1
(43) Pub. Date: Mar. 8, 2012

(54) IMAGE PROCESSING APPARATUS AND IMAGE PROCESSING METHOD

(76) Inventors: Yuya Horiuchi, Kanagawa (JP); Shojiro Shibata, Kanagawa (JP); Takaaki Fuchie, Kanagawa (JP)

(21) Appl. No.: 13/221,207

(22) Filed: Aug. 30, 2011

(30) Foreign Application Priority Data
Sep. 2, 2010 (JP) 2010-196714

(51) Int. Cl. G06K 9/36

(52) U.S. Cl. 382/166

(57) ABSTRACT

An image processing apparatus includes: an orthogonal transforming section which performs an orthogonal transform for image data to generate a transform coefficient; and a quantization factor detecting section which detects a quantization factor used in a previous encoding process, using the transform coefficient, wherein the quantization factor detecting section independently performs a process of detecting the quantization factor from the transform coefficient generated by orthogonally transforming a luminance component of the image data and a process of detecting the quantization factor from the transform coefficient generated by orthogonally transforming a color difference component of the image data.

### FIELD

The present disclosure relates to an image processing apparatus and an image processing method which are capable of reliably detecting a quantization factor used in the previous encoding process.

### BACKGROUND

In the related art, when transferring video data between television broadcasting stations, or when copying video data using a plurality of video recorders (VTR devices), the compressed and encoded video data is decompressed and decoded and is again compressed and encoded. Thus, an encoder and a decoder are necessary to be connected in series and in tandem.

These days, instead of the MPEG (Moving Picture Experts Group) technique, the AVC (Advanced Video Coding) technique has widely been used ranging from the usage of low speed and low image quality such as a television phone of a mobile phone to moving pictures of large capacity and high image quality such as high definition television broadcasting. However, AVC uses combination of algorithms, including motion compensation, inter-frame prediction, DCT and entropy encoding, and is improved compared with MPEG in that it can achieve the same quality with about half the amount of data.

In particular, according to AVC for only intra-frame coding (hereinafter, referred to as “AVC-Intra”), an optimal value of a quantization parameter QP is determined for quantization by matching with a bit rate which is a target. However, the value of the quantization parameter QP at this time is not limited to a value thereof used in the previous encoding process. If the value of the quantization parameter QP different from the value used in the previous encoding process is used, distortion occurs due to rounding during re-quantization, which causes degradation in image quality when dubbing is repeated.

Thus, a so-called “back search” technique is employed to reduce deterioration in video quality due to repetition of the compression and encoding process and the decompression and decoding process when the encoder and the decoder are connected in series and in tandem. For example, International Publication WO2009/035149 discloses a technique of detecting a quantization matrix Qmatrix or a quantization parameter QP which is a quantization factor used in the previous encoding process by the back search, when the AVC coding is employed. By using the detected quantization factor again, it is possible to reduce errors during dubbing, thereby enhancing a dubbing characteristic. Further, JP-A-2009-71520 discloses a technique of performing an encoding process using the back search. Here, the “back search” refers to a method of detecting the quantization factor used in the previous encoding process, using the characteristic that the sum of residues of a discrete cosine transfer (DCT) coefficient becomes the smallest when the quantization factor used in the previous compression and encoding process is used.

### SUMMARY

However, in AVC-Intra, the prediction is performed using peripheral pixels, and information on a difference image disappears when the prediction through the peripheral pixels completely comes true. Thus, there occurs a phenomenon that the DCT coefficient is not present even though the image information is present. Further, in the back search in the related art, the quantization matrix Qmatrix or the quantization parameter QP is detected using a DCT coefficient of a luminance component. Thus, if the prediction through the peripheral pixels completely comes true and the DCT coefficient of the luminance component is not present, it is difficult to detect the quantization matrix Qmatrix or the quantization parameter QP by the back search.

Accordingly, it is desirable to provide an image processing apparatus and an image processing method which are capable of reliably detecting a quantization factor used in the previous encoding process compared with the back search in the related art.

An embodiment of the present disclosure is directed to an image processing apparatus including: an orthogonal transforming section which performs an orthogonal transform for image data to generate a transform coefficient; and a quantization factor detecting section which detects a quantization factor used in a previous encoding process, using the transform coefficient, wherein the quantization factor detecting section independently performs a process of detecting the quantization factor from the transform coefficient generated by orthogonally transforming a luminance component of the image data and a process of detecting the quantization factor from the transform coefficient generated by orthogonally transforming a color difference component of the image data.

In this embodiment, the quantization factor used in the previous encoding process is detected using the transform coefficient obtained by performing the orthogonal transform for the image data by the orthogonal transforming section. In this quantization factor detection, a luminance back search process of detecting the quantization factor from the transform coefficient generated by orthogonally transforming the luminance component of the image data and a color difference back search process of detecting the quantization factor from the transform coefficient generated by orthogonally transforming a color difference component of the image data, are independently performed. Here, for example, in a case where the quantization factor is detected from the transform coefficient generated by orthogonally transforming the luminance component of the image data, the detected quantization factor is determined as the quantization factor used in the previous encoding process. Further, in a case where the quantization factor is not able to be detected from the transform coefficient generated by orthogonally transforming the luminance component of the image data, the quantization factor detected from the transform coefficient generated by orthogonally transforming the color difference component of the image data is determined as the quantization factor used in the previous encoding process. Further, in a case where a quantization parameter and a quantization matrix are detected as the quantization factor, the quantization matrix used in the previous encoding process is detected using the transform coefficient, and then the quantization parameter is detected using the detected quantization matrix. Further, the image processing apparatus further includes a pre-encoding section which detects the quantization factor in which the amount of codes generated when the image data is encoded is equal to or smaller than a target code amount; a quantization setting section; and an encoding section. The quantization setting section selects, in a case where the quantization factor is not able to be detected by the back search, or in a case where the amount of the codes generated when the image data is encoded using the detected quantization factor is greater than the target code amount, the quantization factor detected in the pre-encoding section, and selects, in a case where the amount of the codes generated when the image data is encoded using the quantization factor detected by the quantization factor detecting section is equal to or smaller than the target code amount, the quantization factor detected by the back search. The encoding section performs an encoding process using the selected quantization factor.

Another embodiment of the present disclosure is directed to an image processing method performed in an image processing apparatus which performs an encoding process for image data, the method including: performing an orthogonal transform for image data to generate a transform coefficient; and independently performing a process of detecting the quantization factor from the transform coefficient generated by orthogonally transforming a luminance component of the image data and a process of detecting the quantization factor from the transform coefficient generated by orthogonally transforming a color difference component of the image data.

According to the embodiments of the present disclosure, the process of detecting the quantization factor from the transform coefficient generated by orthogonally transforming the luminance component of the image data and the process of detecting the quantization factor from the transform coefficient generated by orthogonally transforming the color difference component of the image data, are independently performed. Thus, for example, in a case where the quantization factor is not able to be detected from the transform coefficient generated by orthogonally transforming the luminance component of the image data, the quantization factor detected from the transform coefficient generated by orthogonally transforming the color difference component of the image data is determined as the quantization factor used in the previous encoding process. Accordingly, it is possible to reliably detect the quantization factor used in the previous encoding process, compared with a case where only the transform coefficient generated by orthogonally transforming the luminance component is used for detection.

### BRIEF DESCRIPTION OF THE DRAWINGS

FIG. 1 is a diagram illustrating the relationship between a quantization parameter QP and the sum Σr of residues r when an image that has not yet undergone any encoding process is input.

FIG. 2 is a diagram illustrating the relationship between a quantization parameter QP and the sum Σr of residues r as for an input image that has undergone encoding and decoding processes.

FIG. 3 is a diagram illustrating the relationship between a quantization parameter QP and the sum Σr of residues r after standardization by a rescaling factor RF.

FIG. 4 is a diagram illustrating the relationship between a quantization parameter QP and the sum ΣY of evaluation values Y standardized by a rescaling factor RF after scaling residues r by an absolute value |W| of a DCT coefficient.

FIG. 5 is a diagram illustrating a configuration of an image processing apparatus.

FIG. 6 is a diagram illustrating a configuration of a back search section.

FIG. 7 is a flowchart illustrating an operation of an image processing apparatus.

FIG. 8 is a flowchart illustrating a back search process.

FIG. 9 is a flowchart illustrating a detection process of a quantization matrix Qmatrix.

FIG. 10 is a flowchart illustrating a detection process of a quantization parameter QP.

### DETAILED DESCRIPTION

Hereinafter, embodiments of the present disclosure will be described in detail with reference to the accompanying drawings in the following order.

1. Concept of the present disclosure

2. Configuration of image processing apparatus

3. Operation of image processing apparatus

### <1. Concept of the Present Disclosure>

Generally, since the AVC (Advanced Video Coding) coding is irreversible transform, distortion occurs in an original baseband image during encoding and decoding processes. Accordingly, the image quality degrades due to the distortion when the encoding and decoding processes are repeated during dubbing or the like in the case of tandem connection, for example.

Accordingly, in the present embodiment, when an image that has once undergone the encoding and decoding processes is encoded again in intra-frame coding of AVC, a quantization factor used in the previous encoding process is detected. Further, the detected quantization factor is used to prevent quantization rounding, thereby realizing improvement of a dubbing characteristic. The quantization factor refers to a quantization parameter QP, or refers to the quantization parameter QP and a quantization matrix Qmatrix.

Next, characteristic properties and principles in the intra-frame coding will be described in detail. If the quantization factor used in the previous encoding process is used when the image that has once undergone the encoding and decoding processes is encoded again in AVC-Intra, the quantization distortion is already reduced in the previous encoding process, and thus, the quantization distortion does not easily occur any more. In order to use such a characteristic, the quantization factor used in the previous encoding process is detected by a back search.

Hereinafter, a specific method of the back search will be described. It is assumed that the quantization factor includes the quantization parameter QP and the quantization matrix Qmatrix.

In AVC-Intra, during decoding, an integer DCT coefficient W obtained by multiplying a quantization level Z by a rescaling factor RF that is a function of the quantization matrix Qmatrix and the quantization parameter QP is shifted to the left by six bits to be decoded.

(W<<6)=Z×RF (1)

RF={VQmatrix2^{floor(QP/61}}>>4 (2)

In expression (2), “V” is a multiplication factor determined by the AVC standard.

In this way, in the decoding process, since the integer DCT coefficient W can be obtained by multiplying the quantization level Z by the rescaling factor RF, the integer DCT coefficient W in the subsequent encoding process is divided by the rescaling factor RF. That is, if the shifted integer DCT coefficient (W<<6) is divided by the same rescaling factor RF in the subsequent encoding process, the resultant residue r is considered to be “zero”. In consideration of such a property, the residue r obtained by dividing the shifted integer DCT coefficient (W<<6) by the rescaling factor RF obtained by combining various quantization matrixes Qmatrix and quantization parameters QP is calculated. By evaluating the magnitude of the calculated residue r, the quantization matrix Qmatrix and the quantization parameter QP used in the previous encoding process are detected.

Further, in order to improve the accuracy of detection, the following items (i) to (vi) associated with the unique characteristics of AVC-Intra are taken into account, which will be described hereinafter.

### (i) Transform of Rescaling Factor RF During Encoding and Decoding Processes

In AVC-Intra, a DCT section is divided into an integral section and a non-integral section, in which the integral section is referred to as an integer DCT while the non integral section and quantization are collectively referred to as quantization. In AVC-Intra, since positions where the integral section is separated from the non-integral section in the encoding process are different from each other in the encoding process and the decoding process, the integer DCT used in the encoding process (hereinafter, simply referred to as “DCT”) and an integer inverse DCT used in the decoding process (hereinafter, simply referred to as “inverse DCT”) are not in the inverse transform relationship. Accordingly, the DCT coefficient W used in the encoding process does not equal to the DCT coefficient W′ used in the decoding process, and the following expressions (3) and (4) are established. Here, “X” is input data of the DCT section.

$$\begin{matrix}W = A \times {A}^{T} = ( \begin{matrix}1 & 1 & 1 & 1 \\ 2 & 1 & - 1 & - 2 \\ 1 & - 1 & - 1 & 1 \\ 1 & - 2 & 2 & - 1\end{matrix} ) \times {( \begin{matrix}1 & 1 & 1 & 1 \\ 2 & 1 & - 1 & - 2 \\ 1 & - 1 & - 1 & 1 \\ 1 & - 2 & 2 & - 1\end{matrix} )}^{T} & ( 3 ) \\ x = {CW}^{′} {C}^{T} = ( \begin{matrix}1 & 1 & 1 & \frac{1}{2} \\ 1 & \frac{1}{2} & - 1 & - 1 \\ 1 & - \frac{1}{2} & - 1 & 1 \\ 1 & - 1 & 1 & - \frac{1}{2}\end{matrix} ) {{W}^{′} ( \begin{matrix}1 & 1 & 1 & \frac{1}{2} \\ 1 & \frac{1}{2} & - 1 & - 1 \\ 1 & - \frac{1}{2} & - 1 & 1 \\ 1 & - 1 & 1 & - \frac{1}{2}\end{matrix} )}^{T} & ( 4 )\end{matrix}$$

Further, according to these expressions (3) and (4), the following expression (5) is established between the DCT coefficient W and the inverse DCT coefficient W′.

$$\begin{matrix}\begin{matrix}W = ( \begin{matrix}1 & 1 & 1 & 1 \\ 2 & 1 & - 1 & - 2 \\ 1 & - 1 & - 1 & 1 \\ 1 & - 2 & 2 & - 1\end{matrix} ) \times {( \begin{matrix}1 & 1 & 1 & 1 \\ 2 & 1 & - 1 & - 2 \\ 1 & - 1 & - 1 & 1 \\ 1 & - 2 & 2 & - 1\end{matrix} )}^{T} \\ = ( \begin{matrix}1 & 1 & 1 & 1 \\ 2 & 1 & - 1 & - 2 \\ 1 & - 1 & - 1 & 1 \\ 1 & - 2 & 2 & - 1\end{matrix} ) ( \begin{matrix}1 & 1 & 1 & \frac{1}{2} \\ 1 & \frac{1}{2} & - 1 & - 1 \\ 1 & - \frac{1}{2} & - 1 & 1 \\ 1 & - 1 & 1 & - \frac{1}{2}\end{matrix} ) {{W}^{′} ( \begin{matrix}1 & 1 & 1 & \frac{1}{2} \\ 1 & \frac{1}{2} & - 1 & - 1 \\ 1 & - \frac{1}{2} & - 1 & 1 \\ 1 & - 1 & 1 & - \frac{1}{2}\end{matrix} )}^{T} \\ {( \begin{matrix}1 & 1 & 1 & 1 \\ 2 & 1 & - 1 & - 2 \\ 1 & - 1 & - 1 & 1 \\ 1 & - 2 & 2 & - 1\end{matrix} )}^{T}\end{matrix} & ( 5 ) \\ \begin{matrix} = ( \begin{matrix}4 & 0 & 0 & 0 \\ 0 & 5 & 0 & 0 \\ 0 & 0 & 4 & 0 \\ 0 & 0 & 0 & 5\end{matrix} ) {W}^{′} ( \begin{matrix}4 & 0 & 0 & 0 \\ 0 & 5 & 0 & 0 \\ 0 & 0 & 4 & 0 \\ 0 & 0 & 0 & 5\end{matrix} ) \\ = ( \begin{matrix}16 & 20 & 16 & 20 \\ 20 & 25 & 20 & 25 \\ 16 & 20 & 16 & 20 \\ 20 & 25 & 20 & 25\end{matrix} ) ⊗ {W}_{ij}^{′} \\ = {D}_{ij} ⊗ {W}_{ij}^{′}\end{matrix} & \\ ⊗ represents the product of corresponding components in & \\ the matrixes & \end{matrix}$$

In this way, the result obtained by multiplying 16, 20 and 25 by the position (i, j) of the DCT coefficient W′ is W, in which this transform matrix is referred to as “D”. That is, as indicated by the following expression (6), the rescaling factor RF used in the encoding process is obtained by multiplying the rescaling factor RF′ used in the decoding process by the transform matrix D.

RF=RF′×D={VQmatrixD2^{floor(QP/6)}}>>4 (6)

That is, the DCT coefficient W of the input image that has once undergone the encoding process is divided by {VQmatrixD2^{floor(QP/6)}}. That is, the residue r is “zero”, and it is considered that the DCT coefficient W is also divided by {VQmatrixD2^{floor(QP/6)}} in consideration of the transform matrix D of the DCT coefficient W and the DCT coefficient W′.

### (ii) Error During Decoding

In AVC-Intra, the sum of absolute values of differences (SAD: Sum of Absolute difference) between a prediction image and peripheral pixels is encoded. During decoding, the quantization level Z is multiplied by the rescaling factor RF′, but, in order to prevent arithmetic rounding in the decoding process, the rescaling factor RF′ is carried by six bits in advance according to the standard (this is the reason why the DCT coefficient W′ that is shifted by six bits to the left is obtained in the decoding process). Accordingly, the inverse quantization and the inverse DCT are calculated in the state of being carried by six bits. Then, the result is added to the prediction image carried by six bits, and thereafter, a baseband image is obtained by borrowing the sum by six bits. Since data of lower six bits rounds off due to this 6-bit borrowing, the shifted DCT coefficient (W<<6) generated in the subsequent encoding process may not be divided by the rescaling factor RF. That is, in the detection of the quantization parameter QP used in the previous encoding process, instead of the quantization parameter QP in which the residue r becomes “zero”, the quantization parameter QP in which the residue r becomes a minimum value may be detected.

Since an error E during the decoding process may become a negative value, the value of the actual residue r and a value obtained by subtracting the residue r from the rescaling factor RF are compared, and then the smaller one is determined as an evaluation value Y.

For example, it is assumed that the rescaling factor RF is 3600 and the DCT coefficient W is 7200.

If there is no error E, the residue r is represented as the following expression (7).

r=W%RF=7200%3600=0 (7)

In reality, the error E is not able to be estimated, but if E is −2 and the residue r is simply determined as the evaluation value Y, the evaluation value Y is obtained as a value shown in the following expression (8), which makes it difficult to detect the residue r as a minimum value.

Y=r=(W+E)%RF=3598 (8)

Here, if the above-described method is used, the evaluation value Y becomes an absolute value of the error as shown in the following expression (9).

Y=min[r,(RF−r)]=min[3598,2]=2 (9)

(iii) Characteristics of Residual Curve and Cycle of Quantization Parameter QP

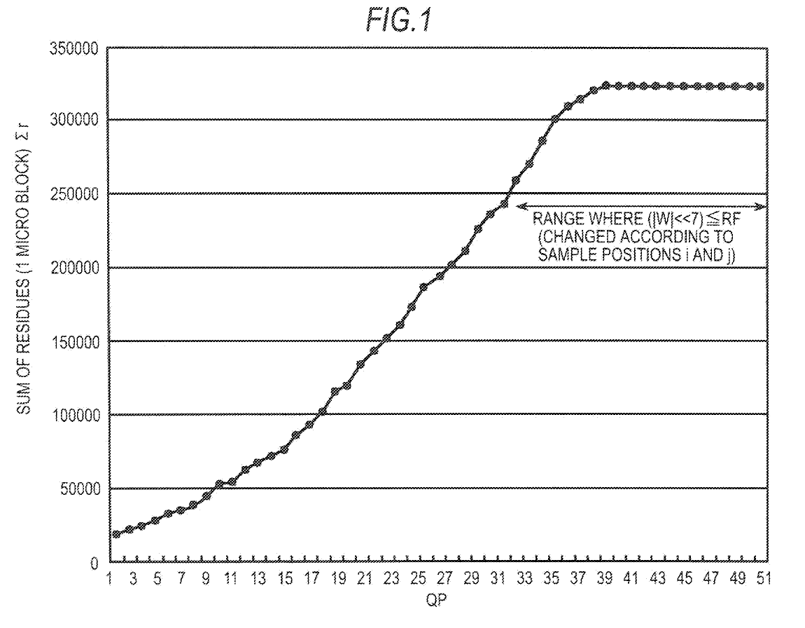

As the input image that has not yet undergone the encoding process, the 6-bit shifted DCT coefficient (W<<6) is divided by the rescaling factors RF obtained from various quantization parameters QP to calculate the residues r. Here, if the horizontal axis represents the quantization parameter QP and the vertical axis represents the sum Σr of residues r, a curve sloping from right to left shown in FIG. 1 is obtained.

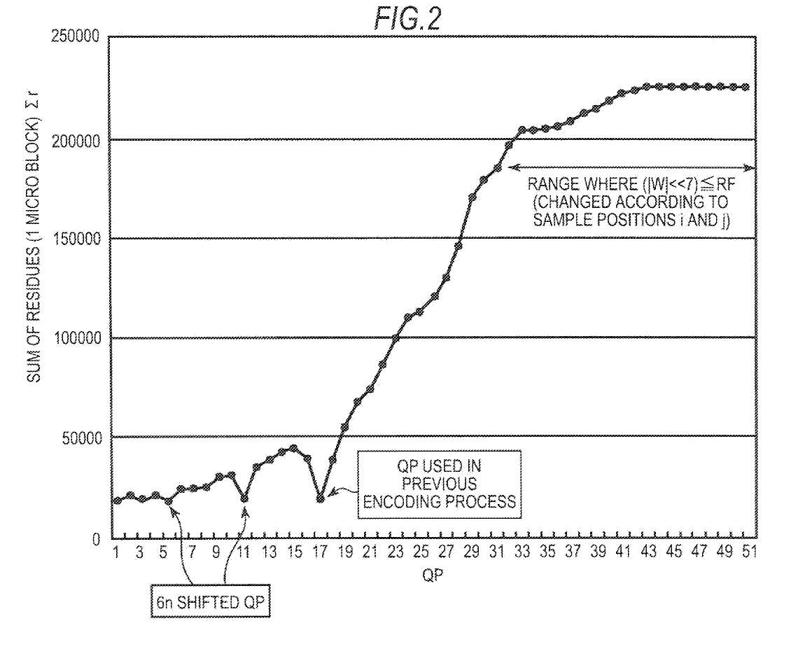

Similarly, with respect to the input image that has already undergone the encoding and decoding processes, the 6-bit shifted DCT coefficient (W<<6) is divided by the rescaling factors RF obtained from various quantization parameters QP to calculate the residues r. Here, if the horizontal axis represents the quantization parameter QP and the vertical axis represents the sum Σr of residues r, a curve shown in FIG. 2 is obtained. In this case, even though a minimum value of the sum Σr of the residues r occurs, the curve tends to slope from right to left. Regardless of whether or not the encoding and decoding processes have been already carried out, the sum Σr of the residues r becomes smaller as the quantization parameter QP gets smaller.

Accordingly, if the sums Σr of the residues r obtained from various quantization parameters QP are simply evaluated in magnitude, the quantization parameter QP smaller than the quantization parameter QP used in the previous encoding process may be falsely detected as a minimum value. In order to solve this problem, the value of the residue r standardized by the rescaling factor RF is used as the evaluation value Y.

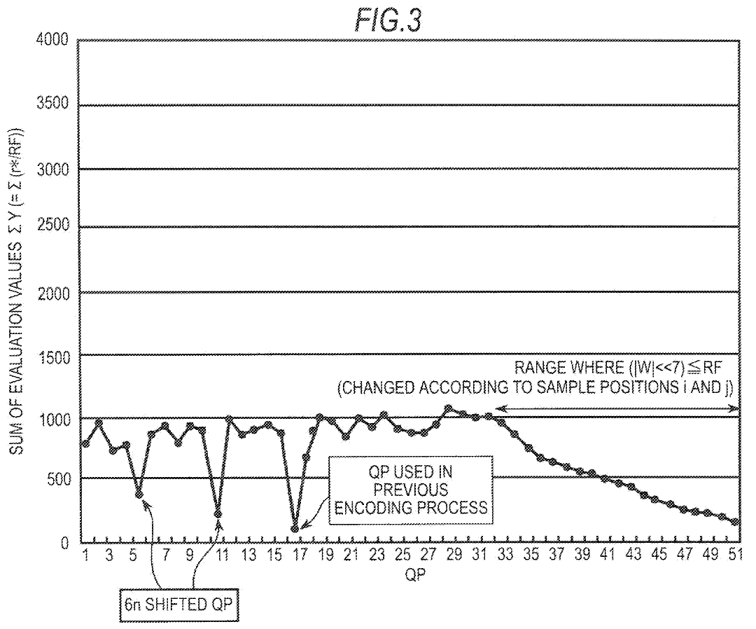

FIG. 3 shows the relationship between the sum ΣY of the evaluation values Y and the quantization parameter QP at this time. It is obvious from FIG. 3 that the sum ΣY of the evaluation values Y with respect to the quantization parameter QP used in the previous encoding process is smaller than the sum ΣY of the evaluation values Y with respect to the 6n-shifted quantization parameter QP.

Further, as shown in FIGS. 1 and 2, in the quantization parameter QP in which (|W|<<7)≦RF, a range where values of the evaluation values Y (absolute values of the residues r) are plotted flat tends to occur. If the standardization by the rescaling factor RF is carried out, this range is monotonously reduced (see FIG. 3), which causes the false detection.

In this case, if the division is carried out with the same rescaling factor RF, the residue r statistically becomes larger as the DCT coefficient W increases. Thus, the residue r is scaled with the absolute value |W| of the DCT coefficient, and then the standardization is carried out with the rescaling factor RF. Accordingly, if the DCT coefficient W capable of having a large residue r has a small residue, this is considered not accidental, which allows weighting (since the DCT coefficient W usually becomes larger as the frequency component becomes lower, the lower frequency component is weighted).

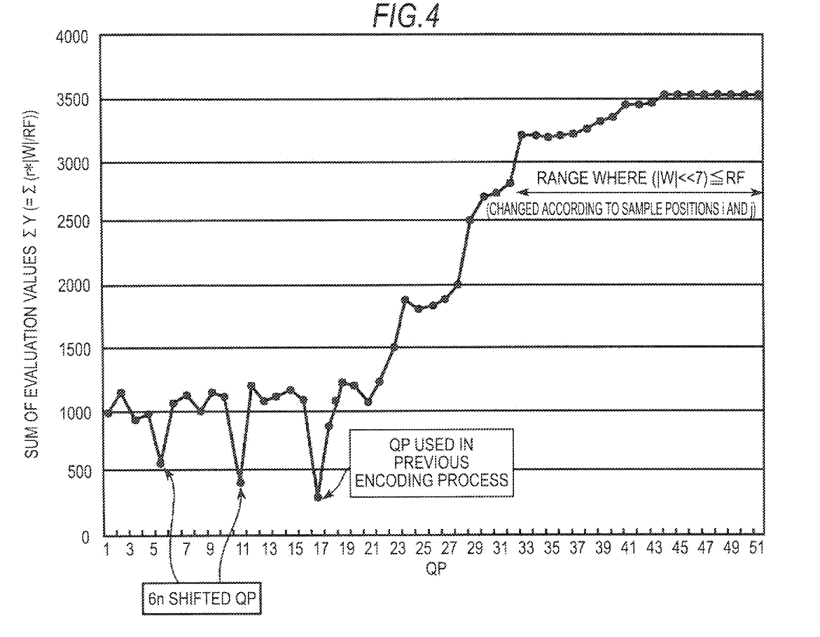

FIG. 4 illustrates the relationship between the sum ΣY of the evaluation values Y standardized by the rescaling factor RF and the quantization parameter QP, after the residue R is scaled by the absolute value |W| of the DCT coefficient. It can be seen from FIG. 4 that there is little change between the sum ΣY of the evaluation values Y with respect to the quantization parameter QP used in the previous encoding process and the sum ΣY of the evaluation values Y with respect to the 6n-shifted quantization parameter QP, compared with the curve in FIG. 3.

Further, the standardization with the rescaling factor RF may be carried out only in a range where the sum ΣY of the evaluation values Y slopes with (|W|<<7)>RF, and in the other ranges, the absolute value |W| of the DCT coefficient W may be used as the evaluation value Y.

In this way, after the residue r is scaled by the absolute value |W| of the DCT coefficient, the sum ΣY of the evaluation values Y standardized by the rescaling factor RF is used. If such a sum ΣY of the evaluation values Y is used, the sum ΣY of the evaluation values Y becomes the smallest in the range where (|W|<<7)≦RF, due to the standardization by the rescaling factor RF. Accordingly, it is possible to reliably prevent the false quantization parameter QP from being detected as the quantization parameter QP used in the previous encoding process.

### (iv) Cycle of the Quantization Parameter QP

According to the specification of AVC-Intra, if the quantization parameter QP is changed by ±6, the rescaling factor RF is multiplied by ±2. Accordingly, if the sum Σr of the residues r has a minimum value with a certain quantization parameter QP, the sum Σr of the residues r may have a minimum value even with QP±6n (n=1, 2, . . . ) (see FIG. 3).

Thus, when the above evaluation value Y is simply evaluated, the 6n-shifted quantization parameter QP may be detected. Accordingly, if the minimum value is present in the quantization parameter QP that is 6n larger than the quantization parameter QP in which the sum Σr of the residues r becomes the smallest, this quantization parameter QP is employed.

Specifically, about five quantization parameters QP are stored in sequence in an ascending order of the sums Σr of the residues r. Then, the quantization parameter QP in which the sum Σr of the residues r is the smallest is compared with the quantization parameter QP in which the sum Σr of the residues r is the second smallest. Here, if there is a difference of 6n between the quantization parameters QP, the larger quantization parameter QP is adopted. Further, the adopted quantization parameter QP is compared with the quantization parameter QP in which the sum Σr of the residues r is the third smallest. If there is a difference of 6n between the quantization parameters QP, the larger quantization parameter QP is adopted, thereby performing 6n replacement of the quantization parameter QP.

In this way, if a plurality of minimum values of the sums Er of the residues r is detected, the quantization parameter QP which is large by 6n is preferentially adopted even though the residue r is not the smallest. Thus, it is possible to suppress the 6n-shifted quantization parameter QP from being falsely detected as the quantization parameter QP used in the previous encoding process.

Further, by confirming whether the plurality of sums Σr of the detected residues r has the cycle of 6n, it is possible to suppress an accidental minimum value from being falsely detected as the quantization parameter QP used in the previous encoding process.

### (v) Reduction Method of Calculation Amount

The image processing apparatus according to the present embodiment, as described above, calculates the rescaling factor RF with respect to various quantization parameters QP, and detects the quantization parameter QP used in the previous encoding process by using the evaluation value Y calculated from the residue r. Accordingly, as the number of quantization parameters QP which may be possibly adopted increases, the processing amount for calculation and evaluation increases. In order to prevent this problem, if the approximate value of the quantization parameter QP used in the previous encoding process is already known, only the quantization parameters QP around it are included in the search range, thereby reducing the amount of calculation.

(vi) The Following Conditions are Also Taken into Consideration.

Even though the intra-frame prediction mode is different from that used in the previous encoding process, the rate of detection can be maintained by carrying out the 6n replacement described in the above item (iv). Further, this is similarly applied to the case where the approximate value of the quantization parameter QP is already known. This focuses on the problem occurring when the prediction mode is switched to a mode different from that used in the previous encoding process. However, even though the prediction mode is different from that used in the previous encoding process, the present embodiment can deal with this case.

It is assumed that there are already defined several patterns of quantization matrixes Qmatrix (for example, they can be identified by ID numbers or the like). That is, since the rescaling factor RF changes as the quantization matrix Qmatrix changes, it is also necessary to detect the quantization matrix Qmatrix in addition to the quantization parameter QP.

That is, by changing the combination of the quantization matrix Qmatrix and the quantization parameter QP in a macro block unit, the rescaling factor RF is calculated for each quantization matrix Qmatrix and each quantization parameter QP. As described above with reference to FIG. 2, the minimum value of the residues r has the cycle of 6n with respect to the quantization parameter QP. Even though the quantization parameter QP is shifted by 6n, there is no problem as long as the quantization matrix Qmatrix is detected. Thus, if the approximate value of the quantization parameter QP used in the previous encoding process is known, it is enough to perform the evaluation with the six successive quantization parameters QP including the value of the quantization parameter QP.

After performing a quantization matrix detection process of detecting the quantization matrix Qmatrix used in the previous encoding process, in consideration of the above description, based on the above characteristic viewpoints, the image processing apparatus performs the back search process of detecting the quantization parameter QP using the quantization matrix Qmatrix.

### <2. Configuration of Image Processing Apparatus>

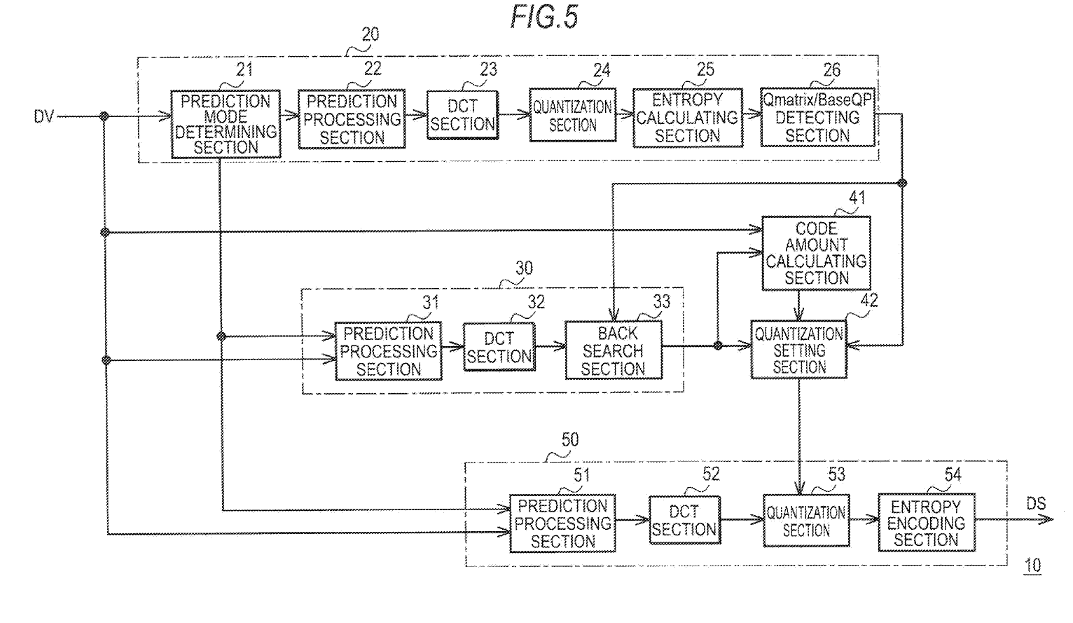

FIG. 5 illustrates a configuration of the image processing apparatus. The image processing apparatus 10 includes a first pre-encoding section 20 which performs a first pre-encoding, a second pre-encoding section 30 which performs a second pre-encoding, a code amount calculating section 41, a quantization setting section 42, and an encoding section 50 which performs a main encoding. The first pre-encoding section 20 includes a prediction mode determining section 21, a prediction processing section 22, a DCT section 23, a quantization section 24, an entropy calculating section 25, and a Qmatrix/BaseQP detecting section 26. The second pre-encoding section 30 includes a prediction processing section 31, a DCT section 32, and a back search section 33. The encoding section 50 includes a prediction processing section 51, a DCT section 52, a quantization section 53, and an entropy encoder 54.

The prediction mode determining section 21 of the first pre-encoding section 20 determines an intra-frame prediction mode on the basis of input image data DV. The prediction mode determining section 21 outputs the determined intra-frame prediction mode to the prediction processing section 22, the second pre-encoding section 30 and the encoding section 50.

The prediction processing section 22 generates prediction image data on the basis of the intra-frame prediction mode determined in the prediction mode determining section 21. Further, the prediction processing section 22 calculates a difference between the input image data and the generated prediction image data to output difference image data to the DCT section 23.

The DCT section 23 generates the integer DCT coefficient from the difference image data by orthogonal transform due to the discrete cosine transform, and then outputs the result to the quantization section 24.

The quantization section 24 quantizes the DCT coefficient output from the DCT section 23 to generate quantization data. Further, the quantization section 24 outputs the generated quantization data to the entropy calculating section 25.

The entropy calculating section 25 counts the occurrence frequency of each value when the smallest quantization parameter QP is used among the quantization parameters QP used in quantization, and calculates the occurrence frequency in each quantization parameter QP from the occurrence frequency in the smallest quantization parameter QP. The entropy calculating section 25 calculates the entropy in each quantization parameter QP from the calculated occurrence frequency and then outputs the result to the Qmatrix/BaseQP detecting section 26.

The Qmatrix/BaseQP detecting section 26 calculates the amount of codes which are predicted to be generated for each quantization parameter QP from the entropy calculated in the entropy calculating section 25, and detects the quantization matrix Qmatrix and a base quantization parameter BaseQP for realization of a target code amount. The Qmatrix/BaseQP detecting section 26 outputs the detected quantization matrix Qmatrix and base quantization parameter BaseQP to the back search section 33 and the quantization setting section 42.

The prediction processing section 31 of the second pre-encoding section 30 generates prediction image data on the basis of the input image data DV and the intra-frame prediction mode determined in the prediction mode determining section 21 of the first pre-encoding section 20. Further, the prediction processing section 31 calculates a difference between the input image data and the generated prediction image data to output the difference image data to the DCT section 32.

The DCT section 32 generates an integer DCT coefficient from the difference image data by orthogonal transform due to the discrete cosine transform, and then outputs the result to the back search section 33.

The back search section 33 serves as a quantization factor detecting section, and detects the quantization factor used in the previous encoding process using the transform coefficient generated in the DCT section 32. The back search section 33 independently performs a luminance back search of detecting the quantization factor from the transform coefficient generated by orthogonally transforming a luminance component of image data and a color difference back search of detecting the quantization factor from the transform coefficient generated by orthogonally transforming a color difference component. Further, in a case where the back search section 33 detects the quantization factor from the transform coefficient generated by orthogonally transforming the luminance component of the image data, the back search section determines the detected quantization factor as the quantization factor used in the previous encoding process. Further, in a case where the back search section 33 is not able to detect the quantization factor from the transform coefficient generated by orthogonally transforming the luminance component of the image data, the back search section 33 determines the quantization factor detected from the transform coefficient generated by orthogonally transforming the color difference component of the image data as the quantization factor used in the previous encoding process.

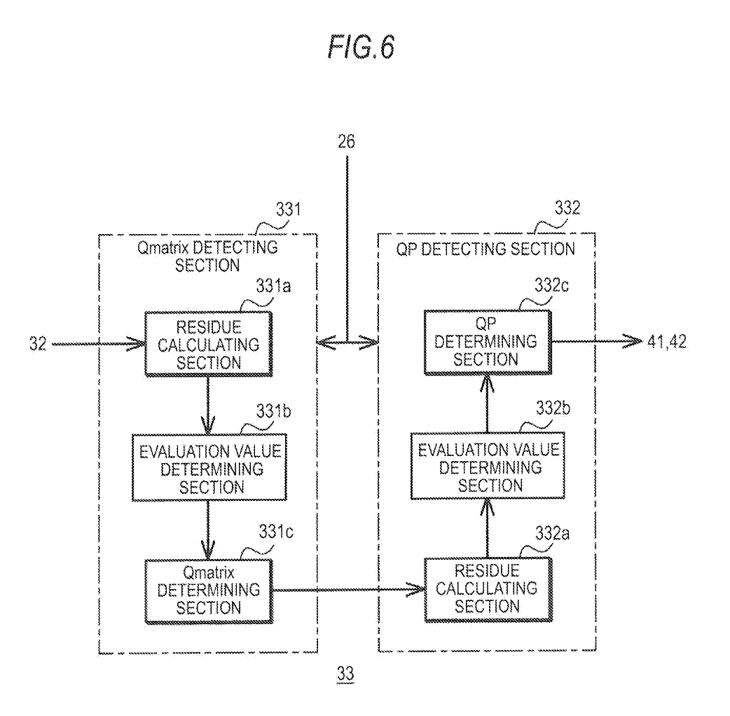

As shown in FIG. 6, the back search section 33 includes a Qmatrix detecting section 331 and a QP detecting section 332. Further, the Qmatrix detecting section 331 includes a residue calculating section 331a, an evaluation value determining section 331b, and a Qmatrix determining section 331c. The QP detecting section 332 includes a residue calculating section 332a, an evaluation value determining section 332b, and a QP determining section 332c.

The residue calculating section 331a of the Qmatrix detecting section 331 calculates the residue r by dividing the DCT coefficient output from the DCT section 32 by the rescaling factor RF. The residue calculating section 331a outputs the calculated residue r to the evaluation value determining section 331b.

As described in the item “(iii) characteristics of residual curve and cycle of quantization parameter QP”, the evaluation value determining section 331b further standardizes the value of residue r by the rescaling factor RF to generate the evaluation value Y. The evaluation value determining section 331b outputs the generated evaluation value Y to the Qmatrix determining section 331c.

The Qmatrix determining section 331c compares the evaluation value Y with various quantization matrixes Qmatrix, and then outputs the quantization matrix Qmatrix in which the evaluation value Y is the smallest as the quantization matrix Qmatrix used in the previous encoding process, to the QP detecting section 332.

The residue calculating section 332a of the QP detecting section 332 divides the DCT coefficient output from the DCT section 32 by the rescaling factor RF obtained from various quantization parameters QP, and then supplies the result to the evaluation value determining section 332b.

As described in the item “(iii) characteristics of residual curve and cycle of quantization parameter QP”, the evaluation value determining section 332b standardizes the value of residue r by the rescaling factor RF to generate the evaluation value Y, using the quantization matrix Qmatrix detected by the Qmatrix detecting section 331. The evaluation value determining section 332b outputs the generated evaluation value Y to the QP determining section 332c.

The QP matrix determining section 332c compares the evaluation value Y with various quantization parameters QP, and then determines the quantization parameter QP in which the evaluation value Y is the smallest as the quantization parameter QP used in the previous encoding process.

In this way, the back search section 33 detects the quantization matrix Qmatrix and the quantization parameter QP, and outputs the detected quantization matrix Qmatrix and quantization parameter QP to the code amount calculating section 41 and the quantization setting section 42. Further, the back search section 33 defines the search range on the basis of the quantization matrix Qmatrix and the base quantization parameter BaseQP supplied from the Qmatrix/BaseQP detecting section 26, to thereby reduce the circuit size.

The code amount calculating section 41 calculates the amount of codes generated when the encoding process is performed using the quantization matrix Qmatrix and the quantization parameter QP output from the back search section 33. Further, the code amount calculating section 41 outputs the code amount determination result indicating whether the calculated amount of the generated codes is in the target code amount, to the quantization setting section 42.

The quantization setting section 42 selects the quantization matrix Qmatrix and the quantization parameter QP detected by the back search section 33 or the quantization matrix Qmatrix and the base quantization parameter BaseQP detected by the first pre-encoding section 20, on the basis of the code amount determination result, and then outputs the result to the encoding section 50. If the amount of the codes generated when the quantization matrix Qmatrix and the quantization parameter QP detected by the back search section 33 are used is in the target code amount, the quantization setting section 42 selects the quantization matrix Qmatrix and the quantization parameter QP, and then outputs the result to the encoding section 50. Further, the generated code amount is larger than the target code amount, the quantization setting section 42 selects the quantization matrix Qmatrix and the base quantization parameter BaseQP detected by the first pre-encoding section 20, and then outputs the result to the encoding section 50.

The prediction processing section 51 of the encoding section 50 generates prediction image data on the basis of the input image data DV and the intra-frame prediction mode determined by the prediction mode determining section 21 of the first pre-encoding section 20. Further, the prediction processing section 51 calculates a difference between the input image data and the generated prediction image data and then outputs the difference image data to the DCT section 52.

The DCT section 52 generates the integer DCT coefficient from the difference image data by orthogonal transform due to the discrete cosine transform, and then outputs the result to the quantization section 53.

The quantization section 53 quantizes the DCT coefficient W output from the DCT section 23 using the quantization matrix Qmatrix and the quantization parameter QP selected by the quantization setting section 42 to generate quantization data. Furthermore, the quantization section 53 outputs the generated quantization data to the entropy encoding section 54.

The entropy encoding section 54 carries out arithmetic encoding for the quantization data output from the quantization section 53 to generate the encoded stream DS for output.

### <3. Operation of Image Processing Apparatus>

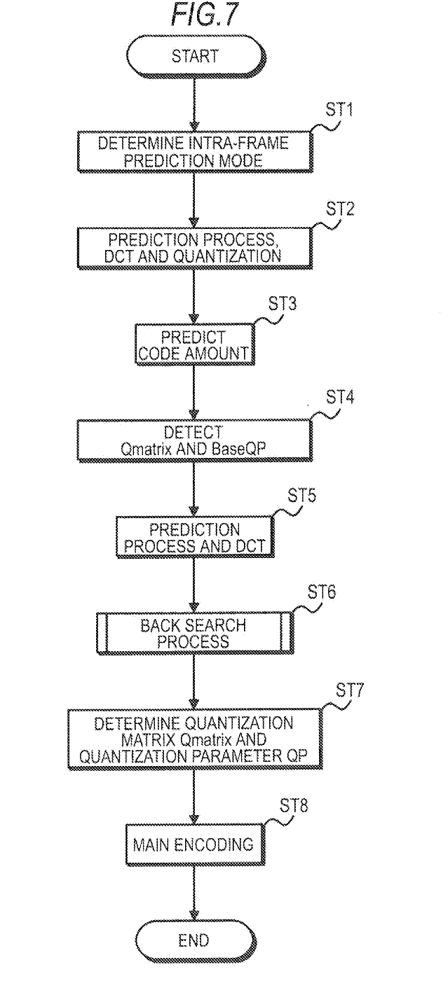

Next, an operation of the image processing apparatus will be described with reference to a flowchart in FIG. 7. In step ST1, the first pre-encoding section 20 determines the intra-frame prediction mode, and then the routine proceeds to step ST2.

In step ST2, the first pre-encoding section 20 performs the prediction process or the DCT and quantization, and then the routine proceeds to step ST3.

In step ST3, the first pre-encoding section 20 performs the code amount prediction. The first pre-encoding section 20 performs the code amount prediction and calculates the prediction value of the generated code amount for each quantization parameter QP.

The first pre-encoding section 20 calculates the occurrence frequency of the absolute value of each value of the quantization coefficient from the occurrence frequency of the absolute value of each value of the quantization coefficient in the smallest quantization parameter QP. Further, the entropy is calculated from the calculated occurrence frequency.

An occurrence probability P[i] of the level i of the quantization coefficient absolute value is calculated by the following expression (10).

P[i]=count[i]/total_count (10)

Further, the entropy “Entropy” is calculated from the following expression (11), using the occurrence probability P[i] calculated with respect to all the quantization coefficient absolute value levels.

Entropy=−1×Σi(P[i]×log(P[i])/log(2)) (11)

By using the entropy calculated as described above, the prediction value of the code amount Estimated_Bits is calculated on the basis of the following expression (12).

Estimated_Bits=Entropy×total_count+sign_bits (12)

Here, “sign_bits” in expression (12) can be expressed as the following expression (13) when the calculated frequency of non-zero coefficients is represented as non_zero_count.

sign_bits=total_count−non_zero_count (13)

Further, in the case of the quantization matrix Qmatrix, a process of counting the occurrence frequency in each position (each_position) in the DCT block, and calculating the prediction value of the generated code amount for each quantization parameter QP is performed, in addition to each quantization coefficient absolute value level (each_level). That is, when the number of values at the time of quantization with the smallest quantization parameter QP is calculated in different quantization parameters QP in which the generated code amount is calculated, each element of the quantization matrix Qmatrix is calculated in consideration of each position in the DCT block. For example, in each position in the DCT block, the occurrence frequency for each of all the quantization coefficient absolute value levels in the different quantization parameters QP in which the generated code amount is calculated, is calculated from the occurrence frequency of the quantization coefficient absolute value levels when the quantization is performed with the smallest quantization parameter QP. Further, this process is performed with respect to all the positions in the DCT block to calculate the entropy as described above, and the prediction value of the code amount is calculated using the calculated entropy.

In step ST4, the first pre-encoding section 20 detects the quantization matrix Qmatrix and the base quantization parameter BaseQP. Since the prediction code amount is calculated in the above-described process, the first pre-encoding section 20 selects the nearest quantization parameter QP in which the prediction code amount is equal to or less than the target code amount, as the base quantization parameter BaseQP. Further, in the case of the quantization matrix Qmatrix, the first pre-encoding section 20 selects the nearest quantization matrix Qmatrix in which the prediction code amount is equal to or less than the target encoding amount.

In step ST5, the second pre-encoding section 30 performs the prediction process or the DCT, and then the routine proceeds to step ST6.

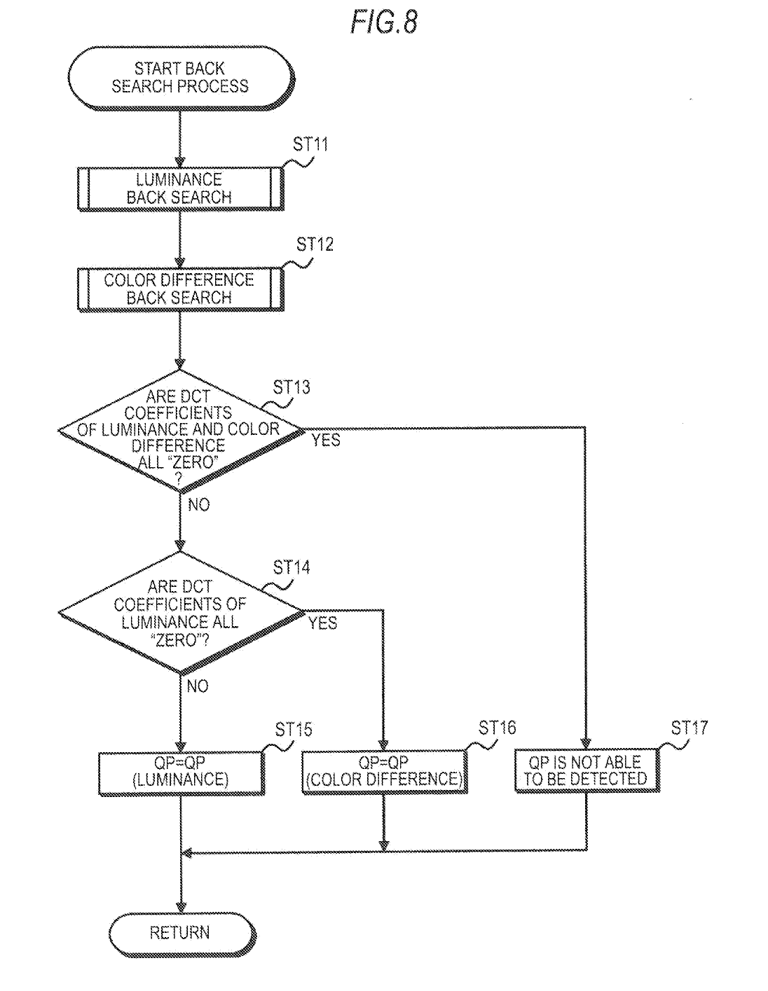

In step ST6, the second pre-encoding section 30 performs a back search process. FIG. 8 is a flowchart illustrating the back search process.

In step ST11, the back search section 33 performs a luminance back search. The back search section 33 performs the back search using the DCT coefficient generated from luminance data in the input image data. In the luminance back search, the quantization matrix Qmatrix is detected, and the quantization parameter QP is then detected using the detected quantization matrix Qmatrix.

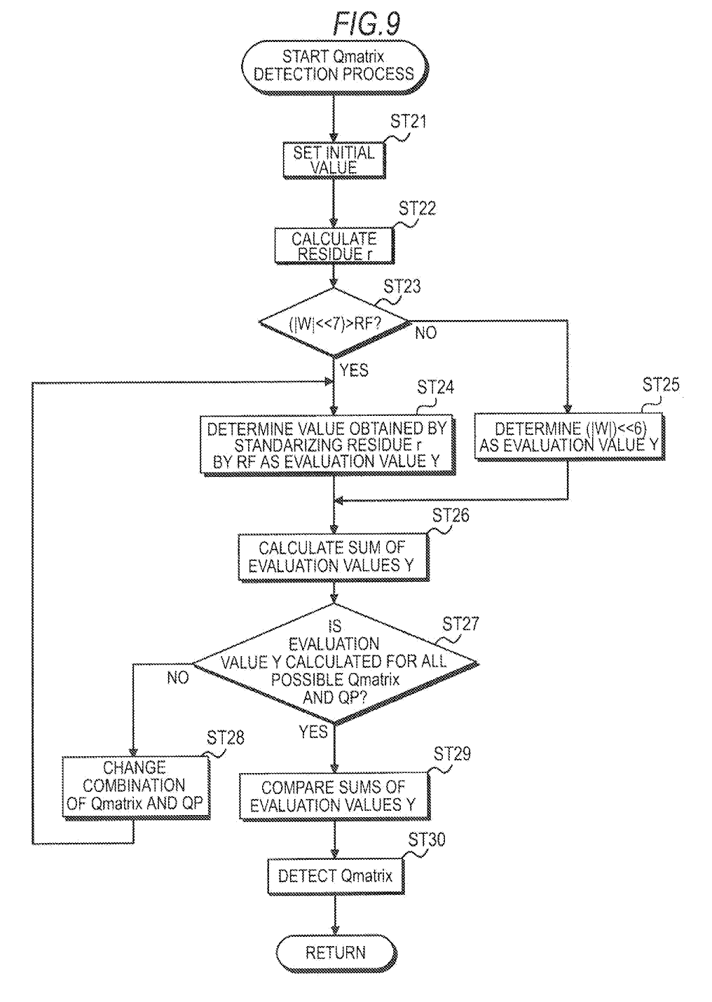

FIG. 9 is a flowchart illustrating the detection process of the quantization matrix Qmatrix. In FIG. 9, only when the absolute value |W| of each DCT coefficient is equal to or less than a standardized threshold (that is, |W|<<7 is equal to or less than RF), the back search section 33 standardizes the residue r by the scaling factor RF to calculate the evaluation value Y. Further, when the absolute value |W| of each DCT coefficient is larger than the standardized threshold, the back search section 33 sets the residue r as the evaluation value Y. Further, the back search section 33 detects the quantization matrix Qmatrix on the basis of the rescaling factor RF in which the evaluation value Y becomes the smallest.

In step ST21, the Qmatrix detecting section 331 of the back search section 33 performs an initial value setting. The Qmatrix detecting section 331 initializes a counter of calculating the parameters or the sum ΣY of the evaluation values Y, or the like. Further, the Qmatrix detecting section 331 sets the search range on the basis of the quantization matrix Qmatrix and the base quantization parameter BaseQP detected by the Qmatrix/BaseQP detecting section 26, and then the routine proceeds to step ST22.

In step ST22, the residue calculating section 331a of the Qmatrix detecting section 331 calculates the residue r. The residue calculating section 331a changes the combination of the quantization matrix Qmatrix and the quantization parameter QP in the macro block unit, and calculates the rescaling factor RF on the basis of the expression (6). Further, the residue calculating section 331a calculates the residue r obtained by dividing |W|<<6 by the rescaling factor RF with respect to each sample in the picture. As described above, the minimum value of the residue r has the cycle of 6n with respect to the quantization parameter QP. Accordingly, even though the quantization parameter QP is shifted by 6n, there is no problem as long as the quantization matrix Qmatrix can be detected. Thus, for example, it is considered enough to perform the evaluation in the search range of 10 stages (for example, range of BaseQP+4 to BaseQP−5) with reference to the base quantization parameter BaseQP.

In step ST23, the evaluation value determining section 331b determines whether (|W|<<7) is larger than RF. If (|W|<<7) is larger than RF, the routine proceeds to step ST24, and if (|W|<<7) is not larger than RF, the routine proceeds to step ST25.

In step ST24, the evaluation value determining section 331b determines a value obtained by standardizing (scaling) the residue r by the rescaling factor RF as the evaluation value Y, and then the routine proceeds to step ST26.

In step ST25, the evaluation value determining section 331b determines (|W|<<6) as the evaluation value Y, and then the routine proceeds to step S26.

In step ST26, the evaluation value determining section 331b calculates the sum ΣY of the evaluation values Y. The evaluation value determining section 331b determines, as the evaluation value Y, a value obtained by performing the standardization and correction of the above item (iii) for the residue r obtained by dividing the shifted DCT coefficient (|W|<<6) by the rescaling factor RF, with respect to 256 (=16×16) samples in the macro block. Further, the evaluation value determining section 331b calculates the sum ΣY of the evaluation values Y for each quantization matrix Qmatrix and each quantization parameter QP, and then the routine proceeds to step ST27.

In step ST27, the evaluation value determining section 331b determines whether the evaluation value Y is calculated for all possible quantization matrixes Qmatrix and quantization parameters QP. If it is determined by the evaluation value determining section 331b that the evaluation value Y is not calculated for all the possible quantization matrixes Qmatrix and quantization parameters QP, and for all the possible quantization matrixes Qmatrix and the quantization parameters QP in the search range, the routine proceeds to ST28, and if it is determined by the evaluation value determining section 331b that the evaluation value Y is calculated for all the possible quantization matrixes Qmatrix and quantization parameters QP, and for all the possible quantization matrixes Qmatrix and the quantization parameters QP in the search range, the routine proceeds to ST29.

In step ST28, the evaluation value determining section 331b changes the combination of the quantization matrix Qmatrix and the quantization parameter QP. The evaluation value determining section 331b changes the combination of the quantization matrix Qmatrix and the quantization parameter QP to a combination in which the evaluation value Y is not calculated, and then the routine returns to step ST24.

In step ST29, the Qmatrix determining section 331c compares the sums ΣY of the evaluation values Y. The Qmatrix determining section 331c compares the sums ΣY of the evaluation values Y for each quantization matrix Qmatrix and each quantization parameter QP in a picture unit (or in a slice unit), and then the routine proceeds to step ST30.

In step ST30, the Qmatrix determining section 331c performs the detection of Qmatrix. The Qmatrix determining section 331c detects the quantization matrix Qmatrix in which the sum ΣY of the evaluation values Y is the smallest, on the basis of the comparison result in step ST29, and determines the detected quantization matrix Qmatrix as the quantization matrix Qmatrix used in the previous encoding process.

The image processing apparatus 10 may calculate a value obtained by multiplying and weighting the residue r by the absolute value |W| of the DCT coefficient, may standardize the multiplied value by the rescaling factor RF, and may determine the result as the evaluation value Y, for example. In this case, since even in a range where the absolute value |W| of each DCT coefficient is large, the image processing apparatus 10 can prevent the false detection by increasing the evaluation value Y in the corresponding range, it is possible to uniformly determine the value standardized by weighting as the evaluation value Y.

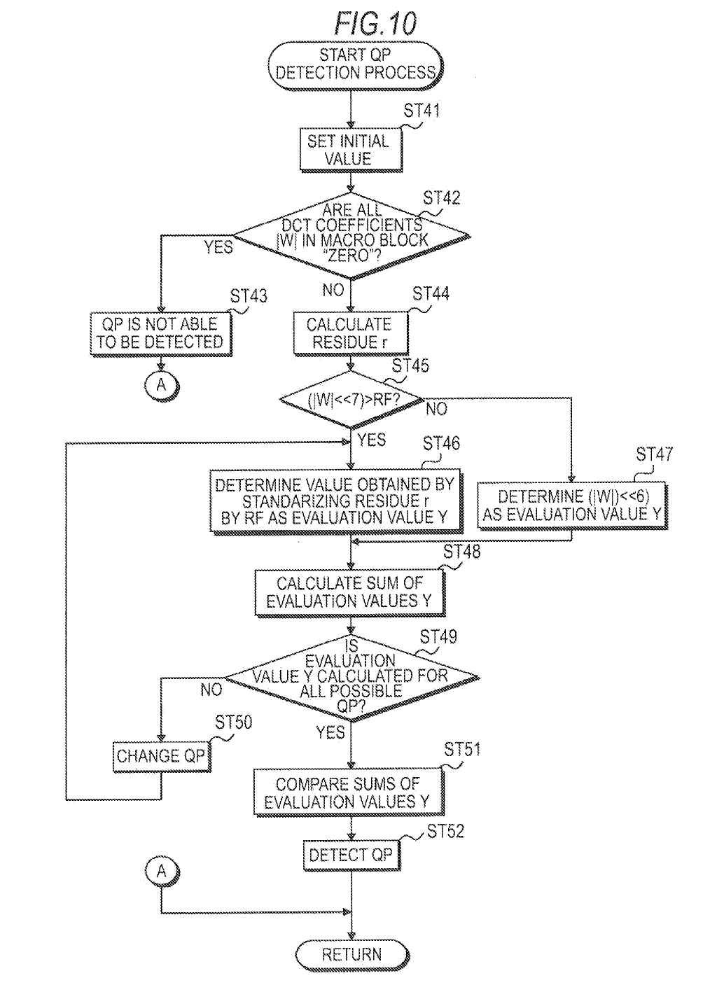

Next, the detection process of the quantization parameter will be described with reference to a flowchart in FIG. 10. In FIG. 10, only when the absolute value |W| of each DCT coefficient is equal to or less then the standardized threshold (that is, |W|<<7 is equal to less than RF), the back search section 33 standardizes the residue r by the rescaling factor RF to calculate the evaluation value Y. Further, when the absolute value |W| of the DCT coefficient is larger than the standardized threshold, the back search section 33 determines the residue r as the evaluation value Y. Further, the back search section 33 detects the quantization parameter QP on the basis of the rescaling factor RF in which the evaluation value Y is the smallest.

The QP detecting section 332 of the back search section 33 calculates the scaling factor RF for each of various quantization parameters QP in the macro block unit, using the absolute value |W| of the DCT coefficient W obtained by the DCT section 32 as an input, and using the quantization matrix Qmatrix detected by the Qmatrix detecting section 331. If the approximate value of the quantization parameter QP used in the previous encoding process is known at this time, the QP detecting section 332 can determine only the QP around it as a detection target, to thereby reduce the amount of calculation.

In step ST41, the QP detecting section 332 sets an initial value. In a similar way to step ST21, the QP detecting section 332 initializes the counter of calculating the parameters or the sum ΣY of the evaluation values Y, or the like, or sets the search range. Further, the QP detecting section 332 initializes the counter of counting DCT coefficients of “zero”, and then the routine proceeds to step ST42.

In step ST42, the QP detecting section 332 determines whether the absolute values |W| of all the DCT coefficients in the macro block are “zero”. The QP detecting section 332 counts the DCT coefficients of “zero” in the macro block, and then determines whether the absolute values |W| of all the DCT coefficient are “zero” on the basis of the counted value. If the absolute values |W| of all the DCT coefficients in the macro block are “zero”, the QP detecting section 332 allows the routine to proceed to step ST43, and if the absolute value |W| of any DCT coefficient is not “zero”, the QP detecting section 333 allows the routine to proceed to step ST44.

In step ST43, the QP detecting section 332 determines that the quantization parameter QP is not able to be detected. If the absolute values |W| of all the DCT coefficients in the macro block are “zero”, the QP detecting section 332 determines the residue r obtained by dividing the absolute value |W| of the DCT coefficient by the re-scaling factor RF as “zero”, with respect to any value of the quantization parameter QP. That is, since the quantization parameter QP is not able to be detected, the QP detecting section 332 determines that the quantization parameter QP is not able to be detected, and then terminates the detection process of the quantization parameter QP.

In step ST44, the residue calculating section 332a of the QP detecting section 332 calculates the residue r. The residue calculating section 332a calculates the residue r obtained by dividing the shifted DCT coefficient (|W|<<6) by the rescaling factor RF calculated on the basis of the expression (6), with respect to each of the samples of 256 (=16×16) in the macro block, and then the routine proceeds to step ST45.

In step ST45, the evaluation value determining section 332b of the QP detecting section 332 determines whether (|W|<<7)>RF is satisfied. If (|W|<<7)>RF is satisfied, the evaluation value determining section 332b allows the routine to proceed to step ST46, and if (|W|<<7)>RF is not satisfied, the evaluation value determining section 332b allows the routine to proceed to step ST47.

In step ST46, the evaluation value determining section 332b determines a value obtained by standardizing the residue r by the scaling factor RF as the evaluation value Y, and then the routine proceeds to step ST48.

In step ST47, the evaluation value determining section 332b determines (|W|<<6) as the evaluation value Y, and then the routine proceeds to step ST48.

In step ST48, the evaluation value determining section 332b calculates the sum ΣY of the evaluation values Y. The evaluation value determining section 332b determines a value obtained by performing the standardization and correction of the above item (iii) for the residue calculated in step ST44 as the evaluation value Y, and calculates the sum ΣY of the evaluation values Y for each quantization parameter QP. Then, the routine proceeds to step ST49.

In step ST49, the evaluation value determining section 332b determines whether the evaluation value Y is calculated for all possible quantization parameters QP. If the sum ΣY of the evaluation values Y is not completely calculated for all the possible quantization parameters QP, that is, the quantization parameters QP in the search range, the evaluation value determining section 332b allows the routine to proceed to ST50, and if the sum ΣY of the evaluation values Y is completely calculated, the evaluation value determining section 332b allows the routine to proceed to ST51.

In step ST50, the evaluation value determining section 332b changes the quantization parameter QP. The evaluation value determining section 332b changes the quantization parameter QP into the quantization parameter QP in which the sum ΣY of the evaluation values Y is not calculated, and then the routine returns to step ST46.

In step ST51, the QP determining section 332c compares the sums ΣY of the evaluation values Y calculated in step ST48. The QP determining section 332c compares the sums ΣY of the evaluation values Y for each quantization parameter QP in a picture unit (or in a slice unit), and then the routine proceeds to step ST52.

In step ST52, the QP determining section 332c detects the quantization parameter QP. The QP determining section 332c detects the quantization parameter QP in which the sum ΣY of the evaluation values Y is the smallest, as the quantization parameter QP used in the previous encoding process. Further, if the evaluation value is the smallest in the quantization parameter which is 6-bit larger than the detected quantization parameter QP, the QP determining section 332c determines the quantization parameter which is 6-bit large as the quantization parameter used in the previous encoding process. Further, in a case where the detected quantization parameter QP is the smallest in the search range and the sum of the evaluation values monotonously increases, it is difficult to confirm that the detected quantization parameter QP is the smallest value, and thus, it is considered that the quantization parameter QP is not detected. Further, since the quantization parameter QP in which the sum ΣY of the evaluation values Y is the smallest is reliably detected using the cycle of 6n, in a case where the detected quantization parameter QP is smaller than a preset threshold (“5”), it may be considered that the quantization parameter QP is not detected.

In this way, the quantization matrix Qmatrix and the quantization parameter QP are detected, and then the routine proceeds to step ST12 in FIG. 8.

In step ST12, the back search section 33 performs a color difference back search. The back search section 33 performs a back search process using the DCT coefficient generated from color difference data in the input image data. In the color difference back search, in a similar way to the luminance back search, the quantization matrix Qmatrix is detected and the quantization parameter QP is then detected using the detected quantization matrix Qmatrix. Further, in the DCT coefficient of the color difference data, the Hadamard transform is used for the coefficient indicating a direct current component. Accordingly, in the color difference back search, the quantization matrix Qmatrix and the quantization parameter QP are detected using a different transform coefficient excluding the transform coefficient indicating the direct current component, and then the routine proceeds to step ST13.

In step ST13, the back search section 33 determines whether the DCT coefficients of luminance and color difference are all “zero”. If any one of the DCT coefficients of luminance and color difference in the macro block is not “zero” in the back search section 33, the routine proceeds to step ST14, and if all the DCT coefficients of luminance and color difference are “zero”, the routine proceeds to step ST17.

In step ST14, the back search section 33 determines whether the DCT coefficients of luminance are all “zero”. If any one of the DCT coefficients of luminance in the macro block is not “zero”, the routine proceeds to step ST15, and if all the DCT coefficients of luminance are “zero”, the routine proceeds to step ST16.

In step ST15, the back search section 33 determines the quantization matrix Qmatrix and the quantization parameter QP detected in the luminance back search as the quantization matrix Qmatrix and the quantization parameter QP detected by the back search section 33.

When the luminance data is used, 16 intra-frame prediction modes are present in one macro block in 4×4 intra prediction blocks, for example, and thus, even though some of them are different from those used in the previous encoding process, it is possible to detect the quantization matrix Qmatrix and the quantization parameter QP. However, when the color difference data is used, since the intra-frame prediction mode in one macro block is only one, it is difficult to detect the quantization matrix Qmatrix and the quantization parameter QP when the intra-frame prediction mode is different from that used in the previous encoding process. Further, the number of the DCT coefficients of the color difference is generally less than that of the DCT coefficients of the luminance data, and the luminance has a high reliability in a statistical amount. Accordingly, except the case where the DCT coefficients of luminance are all “zero”, the quantization matrix Qmatrix and the quantization parameter QP detected in the luminance back search are determined as the quantization matrix Qmatrix and the quantization parameter QP detected by the back search section 33.

In step ST16, the back search section 33 determines the quantization matrix Qmatrix and the quantization parameter QP detected in the color difference back search as the quantization matrix Qmatrix and the quantization parameter QP detected by the back search section 33.

In step ST17, the back search section 33 processes the quantization matrix Qmatrix and the quantization parameter QP as being unable to be detected.

The back search section 33 independently performs the process of detecting the quantization matrix Qmatrix and the quantization parameter QP from the transform coefficient of the luminance component and the process of detecting the quantization matrix Qmatrix and the quantization parameter QP from the transform coefficient of the color difference component, as described above. Further, for example, in a case where the quantization factor is detected from the transform coefficient of the luminance component, the back search section determines the detected quantization factor as the quantization factor used in the previous encoding process. Further, in a case where the quantization matrix Qmatrix and the quantization parameter QP are not able to be detected from the transform coefficient of the luminance component, the back search section 33 determines the quantization matrix Qmatrix and the quantization parameter QP detected from the transform coefficient of the color difference component as the quantization factor used in the previous encoding process. If the detection process is terminated, the back search section 33 allows the routine proceeds to step ST7 in FIG. 7.

In the flowchart of FIG. 8, the color difference back search is performed after the luminance back search, but the luminance back search and the color difference back search may be performed in parallel. Further, in a case where the color difference back search is performed after the luminance back search, when the quantization matrix Qmatrix and the quantization parameter QP are detected in the luminance back search, the color difference back search may not be performed. Further, it is determined whether the DCT coefficients are all “zero” for the luminance component and the color difference component, and the back search may be performed when any DCT coefficient is not “zero”.

In step ST7, the quantization setting section 42 of the image processing apparatus 10 determines the quantization matrix Qmatrix and the quantization parameter QP to be used in the encoding section 50. If the generated code amount calculated by the code amount calculating section 41 using the quantization matrix Qmatrix and the quantization parameter QP detected by the back search section 33 is equal to or less than the target code amount, the quantization setting section 42 outputs the quantization matrix Qmatrix and the quantization parameter QP to the encoding section 50. Further, if the generated code amount is larger than the target code amount, the quantization setting section 42 outputs the quantization matrix Qmatrix and the base quantization parameter BaseQP detected by the first pre-encoding section 20 to the encoding section 50, and the routine proceeds to step ST8.

In step ST8, the encoding section 50 of the image processing apparatus 10 performs the main encoding. The encoding section 50 performs the encoding process of the input image data using the quantization matrix Qmatrix and quantization parameter QP (or base quantization parameter BaseQP) supplied from the quantization setting section 42.

In this way, when the back search is performed to realize improvement of the dubbing characteristic, the image processing apparatus 10 performs the back search using the color difference component in addition to the luminance component. Even though the DCT coefficients of the luminance component are all “zero”, the image processing apparatus 10 can detect the quantization matrix Qmatrix or the quantization parameter QP used in the previous encoding process from the color difference component, by using the color difference component. Further, except that the DCT coefficients of the luminance component are all “zero”, since the quantization matrix Qmatrix or the quantization parameter QP detected using the luminance component is used as the back search result, it is possible to obtain the back search result with high accuracy. Further, by performing the encoding process using the quantization matrix Qmatrix or the quantization parameter QP detected by the above-described back search, it is possible to improve the dubbing characteristic.

Further, the series of processes as described above may be performed by hardware, software or a complex configuration thereof. When the processes are performed using software, it is possible to cause a program in which a process sequence is recorded to be installed for execution to a memory in a computer assembled in exclusive hardware, or to cause the program to be installed for execution in a general-purpose computer capable of executing various processes.

For example, the program may be recorded in advance in a hard disk or a ROM (Read Only Memory) which is a recording medium. Alternatively, the program may be temporarily or permanently stored (recorded) on a removable recording medium such as a flexible disc, CD-ROM (Compact Disc Read Only Memory), MO (Magneto optical) disc, DVD (Digital Versatile Disc), magnetic disc or semiconductor memory. Such a removable recording medium may be provided as so-called “package software”.

The program is installed in the computer from a removable recording medium as described above, but may be transmitted to the computer from a download site in a wireless manner, or may be transmitted to the computer through a network such as a LAN (Local Area Network) or the Internet in a wired manner. In this case, the computer may receive the program transmitted in this way and may install the program on a recording medium such as a built-in hard disk.

Further, the variety of processes disclosed in the description may be performed in a time series manner as described above, or may be performed in parallel or individually according to the process capability of the apparatus for performing the processes or as necessary. For example, the detection of the quantization matrix and the quantization parameter based on the luminance data and the detection of the quantization matrix and the quantization parameter based on the color difference data may be performed in parallel.

The present disclosure is not limited to the above-described embodiments. The embodiments of the present disclosure are exemplary, and thus, it is obvious to those skilled in the art that modifications or substitutes may be made in the range without departing from the spirit of the present disclosure. That is, the appended claims should be considered in order to determine the gist of the present disclosure.

In the image processing apparatus and the image processing method according to the present disclosure, the process of detecting the quantization factor from the transform coefficient generated by orthogonally transforming the luminance component of the image data and the process of detecting the quantization factor from the transform coefficient generated by orthogonally transforming the color difference component of the image data are independently performed. Thus, for example, in a case where the quantization factor is not able to be detected from the transform coefficient generated by orthogonally transforming the luminance component of the image data, the quantization factor detected from the transform coefficient generated by orthogonally transforming the color difference component of the image data is determined as the quantization factor used in the previous encoding process. Accordingly, since it is possible to reliably detect the quantization factor used in the previous encoding process compared with a case where only the transform coefficient generated by orthogonally transforming the luminance component is used, the present technique is suitable for a device in which the encoding process and the decoding process of the image data are repeatedly performed, for example, an editing apparatus of the image data or a recording reproduction apparatus of the image data.

The present disclosure contains subject matter related to that disclosed in Japanese Priority Patent Application JP 2010-196714 filed in the Japan Patent Office on Sep. 2, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An image processing apparatus comprising:
an orthogonal transforming section which performs an orthogonal transform for image data to generate a transform coefficient; and
a quantization factor detecting section which detects a quantization factor used in a previous encoding process, using the transform coefficient,
wherein the quantization factor detecting section independently performs a process of detecting the quantization factor from the transform coefficient generated by orthogonally transforming a luminance component of the image data and a process of detecting the quantization factor from the transform coefficient generated by orthogonally transforming a color difference component of the image data.

2. The image processing apparatus according to claim 1,
wherein the quantization factor detecting section determines, in a case where the quantization factor is detected from the transform coefficient generated by orthogonally transforming the luminance component of the image data, the detected quantization factor as the quantization factor used in the previous encoding process, and determines, in a case where the quantization factor is not able to be detected from the transform coefficient generated by orthogonally transforming the luminance component of the image data, the quantization factor detected from the transform coefficient generated by orthogonally transforming the color difference component of the image data as the quantization factor used in the previous encoding process.

3. The image processing apparatus according to claim 2,
wherein the quantization factor detecting section detects the quantization factor from a different transform coefficient excluding a transform coefficient which represents a direct current component, in a case where the quantization factor is detected from the color difference component.

4. The image processing apparatus according to claim 3,
wherein the quantization factor is a quantization parameter.

5. The image processing apparatus according to claim 4,
wherein the quantization factor detecting section detects, in a case where the quantization factor includes a quantization matrix, the quantization matrix used in the previous encoding process using the transform coefficient, and detects the quantization parameter using the detected quantization matrix.

6. The image processing apparatus according to claim 2, further comprising:
a pre-encoding section which detects the quantization factor in which the amount of codes generated when the image data is encoded is equal to or smaller than a target code amount;
a quantization setting section which selects, in a case where the quantization factor detecting section is not able to detect the quantization factor or in a case where the amount of the codes generated when the image data is encoded using the detected quantization factor is greater than the target code amount, the quantization factor detected in the pre-encoding section, and selects, in a case where the amount of the codes generated when the image data is encoded using the quantization factor detected by the quantization factor detecting section is equal to or smaller than the target code amount, the quantization factor detected in the quantization factor detecting section; and
an encoding section which encodes the image data using the quantization factor selected in the quantization setting section.

7. An image processing method performed in an image processing apparatus which performs an encoding process for image data, the method comprising:
performing an orthogonal transform for image data to generate a transform coefficient; and
independently performing a process of detecting the quantization factor from the transform coefficient generated by orthogonally transforming a luminance component of the image data and a process of detecting the quantization factor from the transform coefficient generated by orthogonally transforming a color difference component of the image data.
